(19) United States
(12) Patent Application Publication
(10) Pub. No.: US 2023/0245182 A1
(43) Pub. Date: Aug. 3, 2023

(54) CHARITABLE PLATFORM INTEGRATION PROCESSING

(71) Applicant: NCR Corporation, Atlanta, GA (US)

(72) Inventors: Lauren Amelia Alderman LaRochelle, Atlanta, GA (US); Kip Oliver Morgan, Atlanta, GA (US); Gina Torcivia Bennett, Lawrenceville, GA (US); Matthew Robert Burris, Atlanta, GA (US)

(21) Appl. No.: 17/587,684

(22) Filed: Jan. 28, 2022

(51) Int. Cl. G06Q 30/02; G06Q 20/36; G06Q 20/40

(52) U.S. Cl. CPC G06Q 30/0279; G06Q 20/36; G06Q 20/405

(57) ABSTRACT

A platform for charitable integration processing is provided. A donor provides a source of valuable funds to fund a recipient digital wallet associated with a donation. The wallet is associated with a generated code and the code provided to the donor. The donor provides the code to a desired recipient and the recipient can redeem the donation via the code during online checkouts, during in-store checkouts, or during cash withdrawals from Automated Teller Machines (ATMs). In an embodiment the donor provides the code on print media to the recipient. In an embodiment, the donor provides the code as an image scanned by a device of the recipient off a display of a donor’s device.

### BACKGROUND

People want to be charitable and give to those in need but often nowadays people do not carry cash with them and rely on various other forms of payment, such as credit card, digital wallets, gift cards, checks, electronic checks, cryptocurrency, etc. People are reluctant to give transients anything other than pocket change or prepaid gift cards although many are willing to give more and often want to give more to help out.

Moreover, some people feel that whatever they give a person in need should be used on what they feel that person is in need of such as food, hygiene products, bedding, clothing, etc. Many people do not give more because of the belief that the recipient will use the money on things that are unnecessary, such as alcohol, tobacco, or drugs and then will still be in need of basic items.

Additionally, credit card theft is pervasive such that even using a credit card at a gas station or retail store runs the risk that the credit card will be stolen. Thus, people do not provide credit card numbers to those in need and likely would not even consider such a situation.

Homeless populations and beggars have become issues for most major cities. It is not uncommon to be asked for money on the sidewalk of any major city. Yet, there are people that want to help but providing help has become a real burden on the donors such that they have to preplan to buy specific items for someone in need and hand deliver it to them or be sure to have money in hand when encountered by someone in need.

Further, COVID19 has exacerbated charitable giving since many donors now do not want to come into contact with those in need for fear of being exposed to the virus. Unfortunately, there is no contactless means by which donors can give to those in need such that COVID19 protocols are adhered to.

There is no easy mechanism by which donors can give to those in need nor is there any secure, safe (from a health perspective), and guaranteed way to place restrictions on a donation to someone in need. As a result, many people in need are not receiving the basic assistance needed for living day to day and many donors are unsure what is the best way that they can help out and mitigate the issue even on the smallest of levels.

### SUMMARY

In various embodiments, a system and methods for charitable platform integration processing are presented.

According to an embodiment, a method for charitable integration processing is provided. A funding source for a donation amount is obtained from a donor. A digital wallet is generated with the donation amount obtained from the funding source. A code is generated and linked to the digital wallet. The code is provided back to the donor for delivery by the donor to a recipient of the donation amount.

### BRIEF DESCRIPTION OF THE DRAWINGS

FIG. 1 is a diagram of a system for charitable platform integration processing, according to an example embodiment.

FIG. 2 is a diagram of a method for charitable platform integration processing, according to an example embodiment.

FIG. 3 is a diagram of another method for charitable platform integration processing, according to an example embodiment.

### DETAILED DESCRIPTION

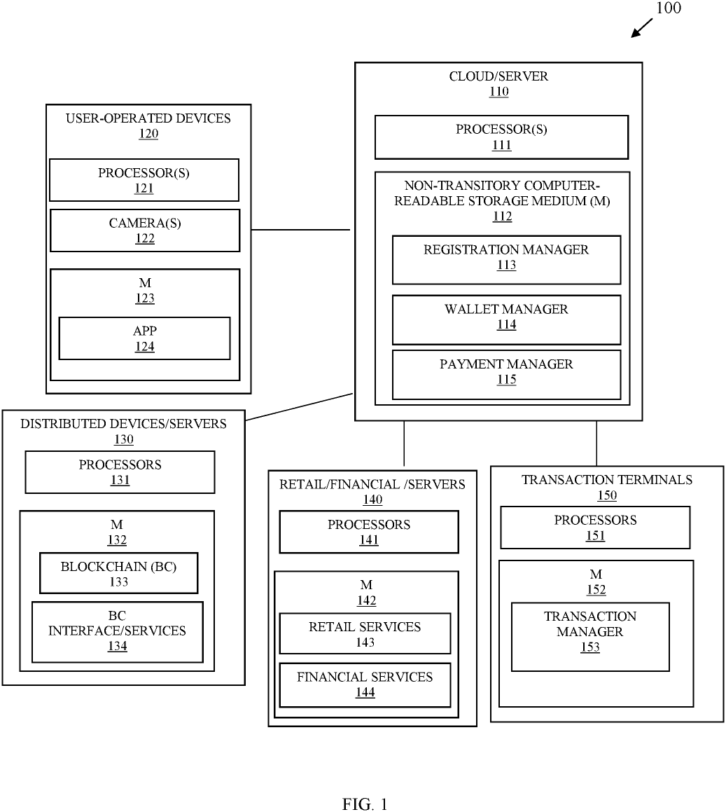

FIG. 1 is a diagram of a system/platform 100 for charitable integration processing, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of charitable platform integration processing, presented herein and below.

System/platform 100 (herein after just “system 100”) provides a processing environment by which a donor can establish a digital donor wallet or account in an easy fashion and deposit valuable funds, such as cryptocurrency and cash. The wallet can be used to provide donations of valuable funds to specific individuals or anonymous individuals by creating a recipient wallet that is funded by a donor. The recipient wallet can have any customized limitations or restrictions placed on the valuable funds as defined by the donor. Moreover, the recipient wallet can be provided to the recipient by the donor in a number of different ways, such as via a scan of a code or via a printed piece of paper with the code. The code can be redeemed by the recipient through online retail stores, transaction terminals of retail stores during checkouts, of even via Automated Teller Machines (ATMs) for cash withdrawals.

Specifics of the charitable platform integration processing to achieve the above-mentioned and other benefits are now discussed with reference to FIG. 1.

As used herein “valuable funds” comprise, prepaid gift cards, cryptocurrency, government-backed currency, and the like. The cryptocurrency can be a stable coin that tracks directly with the U.S. dollar to avoid volatility in value or a non-stable coin that does not directly track to the U.S. dollar and is subject to volatility.

A “donor” is an individual that is providing a donation of valuable funds to a donor-chosen recipient and a “recipient” is an individual or an organization that receives valuable funds from a given donor.

System/Platform 100 comprises a cloud/server 110, user-operated devices 120, distributed devices/servers 130, retail/financial servers 140, and transaction terminals 150.

Cloud/server 110 comprises at least one processor 111 and a non-transitory computer-readable storage medium 112. Medium 112 comprises executable instructions for a registration manager 113, a wallet manager 114, and payment manager 115. The executable instructions when provided to processor 111 from medium 112 cause the processor 111 to perform operations discussed herein and below with respect to 113-115.

User-operated device 120 comprises at least one processor 121, at least one camera 122, and a non-transitory computer-readable storage medium 123. Medium 123 comprises executable instructions for a donor mobile application (app) 124. The executable instructions when provided to processor 121 from medium 123 cause the processor 121 to perform operations discussed herein and below with respect to 124.

Each distributed device/server 130 comprises at least one processor 131 and a non-transitory computer-readable storage medium 132. Medium 132 comprises executable instructions for blockchain (BC) operations 133 and BC interfaces/services 134. The executable instructions when provided to processor 131 from medium 132 cause the processor 131 to perform operations discussed herein and below with respect to 133 and 134.

Each retail/financial server 140 comprises at least one processor 141 and a non-transitory computer-readable storage medium 142. Medium 142 comprises executable instructions for retail services 143 and financial services 144. The executable instructions when provided to processor 141 from medium 142 cause the processor 141 to perform operations discussed herein and below with respect to 143 and 144.

Each transaction terminal 150 comprises at least one processor 151 and a non-transitory computer-readable storage medium 152. Medium 152 comprises executable instructions for a transaction manager 153. The executable instructions when provided to processor 151 from medium 152 cause the processor 151 to perform operations discussed herein and below with respect to 153.

Registration manager 113 interacts via Application Programming Interfaces (APls) with app 124, retailer services 143, BC interfaces/services 134, financial services 144, and transaction manager 153 for purposes of establishing a donor digital wallet (hereinafter just “wallet”) or interacting with an existing wallet of a given donor during registration of a donor. Registration can occur in many different manners.

For example, a donor may initiate registration on user-operated device via app 124 or a donor may initiate registration during a checkout or a transaction with a given retail service 143 or a given financial service 144. A donor may also initiate registration during a checkout within a retail store at a transaction terminal 150 with transaction manager 153.

Workflows associated with user-facing interfaces of BC interface/services 134, retail services 143, financial services 144, and transaction manager 153 are modified to process a donor registration workflow with registration manager 113.

During registration, registration manager 113 collects a variety of information about the donor, such as login identifier, credential, mobile device identifier for user-operated device 120, phone number, email address, mailing address, etc. It is noted that the donor need not provide any information for which the donor is not comfortable in providing other than a login identifier and credential such that a registered donor can be authenticated and linked to prior donations and/or current donations.

In some cases during registration, the donor may voluntarily provide an existing wallet identifier for an existing wallet of the donor that is to be used for donations or the donor is asked to create a new wallet via wallet manager 114 for donations. The donor is then asked an amount of valuable funds that the donor wishes to donate along with any donor-defined restrictions on a recipient that redeems the valuable funds. The donor may fund the valuable funds through an existing wallet of the donor, through cash provided during a checkout at a transaction terminal 150, through credit card providing during a checkout online via retail services 143, through a bank account of the donor with a given financial service 144, or through a cryptocurrency coin maintained on a BC 133 through BC interface/services 134 in an existing cryptocurrency wallet of the consumer.

During registration, the donor provides an amount of the valuable funds being used as a donation, the source of the funds, and any donor-defined restrictions. Wallet manager 114 then creates a new wallet on behalf of the donor with the amount of the valuable funds and links the new wallet to donor. Again, the wallet may be funded with currency obtained via a credit card of the donor, cryptocurrency obtained from an existing cryptocurrency wallet of the donor, cash transferred from a bank account of the donor, or cash provided at a transaction terminal 150 during checkout for a transaction of the donor.

The restrictions placed on a recipient redeeming the valuable funds can include any donor-defined restriction, such as no item associated with alcohol, tobacco, a firearm; only a cash redemption via an Automated Teller Machine (ATM) withdraw; specific category of merchant (grocery, restaurant, convenience store, QuickTrip®, etc.); specific merchant (Kroger®, Publix®, McDonald’s®, QuickTrip®, etc.); time restriction (must use within X time or funds removed such as week, month, year, etc.); specific tax codes; age restrictions (for example cannot be used by a minor or someone under 21 years of age); parental restrictions when the donor is a parent and the recipient is a parent’s child (parental restrictions may include item-based restrictions or specific items that are allowed to be purchased); etc.

Once wallet manager 114 has created the recipient wallet, funded the wallet with funds and by an amount identified by the donor, recorded any donor-based restrictions of redemption following registration, Wallet manager 114 generates an encoded code (for example a Quick Response (QR) code) that identifies the recipient wallet via a wallet identifier. A mapping is maintained between the recipient wallet identifier (provided in the encoded code), the donor identifier, and the donor-identified restrictions.

The generated code is then provided back to the donor. This can occur in a variety of manners, such as via an image displayed for capture on a display of a transaction terminal 150, on a display of a user-operated device 120 being used during registration, in a window generated by retail/financial servers 140, or in a window generated by distributed devices/servers 130. The code can also be texted to the donor via user-operated device 120 and/or emailed to an email account of the donor. The code may also be sent to the recipient via Near Field Communication (NFC) by tapping on a transaction terminal 150.

Once the donor is in possession of the code, the donor can distribute it to any desired recipient in a variety of manners. For example, the donor can print the code on print media (such as paper). The donor can display the code on a display of user-operated device 120 for capturing by a chosen recipient by the recipient using a camera 122 of the recipient’s device 120 to capture the code and store it on the recipient’s corresponding app 124. The code may also be sent by the donor to a recipient through NFC, airdrop®, email, social media direct message, and/or text. Thus, the donor can provide the code to a desired recipient in any number of touchless or contactless manners that adhere to COVID19 health-safety protocols.

In an embodiment, the code is also sent with information about the recipient wallet, such as the usage restrictions, the type of valuable funds, and an amount of the valuable funds. Thus, the code when captured by a recipient also includes text information regarding the amount, the type of valuable funds associated with the amount, and the donor-based restrictions.

Once a recipient is in possession of the code, the recipient can redeem the code through a transaction terminal 150 during checkout by providing the code (via display on recipient device 120 or via printed print out) during payment processing as payment for a recipient transaction. The code can be scanned by a camera or scanner of terminal 150 for entry, provided via NFC, or by a recipient manually entering an identifying number that accompanies the code through a touch keypad or separate keypad of the terminal 150. Transaction manager 153 identifies the code as being generated by cloud/server 110 and uses an API to provide the code and transaction details for the transaction to payment manager 115. The transaction details include item identifiers for items in the transaction, store location, store identifier, current date and time of day, pricing information, etc.

Payment manager 115 provides the code to wallet manager 114 and wallet manager 114 returns the wallet associated with the code along with the donor-based restrictions (using the mapping maintained for the wallet identifier associated with the code and the restrictions, if any) to payment manager 115. Payment manager 115 determines whether the type of valuable funds is a government-backed currency or a cryptocurrency. If the type is a cryptocurrency, payment manager 115 asks wallet manager 114 to convert the cryptocurrency using BC interface/services 134 and BC 133 from the cryptocurrency to a government-backed currency accepted by terminal 150.

Payment manager 115 evaluates the donor-based restrictions against the transaction details provided by terminal 150 and transfers the amount available in the recipient wallet to transaction manager 153 as full or partial payment for the recipient’s transaction.

When a recipient is redeeming the amount in the recipient wallet via an online service, the retail service 143 receives the code from the recipient during payment processing and performs the same processing as was discussed above for a transaction terminal redemption only using the retail service 143 to interact with payment manager 115.

When the recipient is making a cash withdrawal at an ATM using the code, the ATM application identifies the code and provides to payment manager 115. Payment manager 115 interacts with the corresponding financial service 144 to provide the funds associated with the wallet and authorize the cash withdraw (assuming donor-based restrictions are satisfied).

Payment manager 115 and wallet manager 114 maintain history and audit trails for redemptions that link to the donor. App 124 permits a registered donor to obtain or download the history and audit trails for tax purposes.

Additionally, app 124 permits a registered donor to log onto cloud/server 110 link a credit card, a bank account, or a cryptocurrency wallet to provide subsequent donations in the same manners as was discussed above with registration.

In an embodiment, a donor may maintain his/her own donation wallet with wallet manager 114 to use as a source of funds for donations, such that a donor can add funds at any time even without making a specific donation.

In an embodiment, a donor can identify a tax-exempt agency as a specific recipient of a donation. In this situation, the history and audit trail flags these donations with the agencies tax identifier. The donor can then obtain a report identifying a yearly charitable donation total that includes the necessary supporting tax documentation for doing their taxes.

In an embodiment, when a donation is created via the code, a default set amount of time is set for redemption of the funds in the recipient wallet. When that amount of time expires, the wallet is reidentified as being a donor wallet controlled by the donor and which can be used by the donor for other donations or transferred to the donor in a donor linked wallet, to a donor-linked credit card as a credit, or to a donor linked bank account as a deposit to that account. The donor can override the set amount of time for expiration via a user-facing interface to cloud/server 110 accessed through app 124 and/or a web browser.

In an embodiment, when the recipient wallet is created a one-time password may be set on the wallet and encoded in the code.

In an embodiment, during checkout by a donor at a transaction terminal 150 or via online using a retail service 143, the donor is given the option to print the code generated by wallet manager 114 and linked to the recipient wallet. The code is then printed via a printer linked to user device 120 for online checkouts or printed via a receipt printer at terminal 150 during an in-store checkout of the donor. When the code is printed it may also be accompanied with a text description of the type of valuable funds, an amount of the valuable funds, a current date and time, and any donor-based restrictions. Additionally, the print out may include a unique emblem associated with cloud/server 110 representing a trademark of cloud/server.

One now appreciates how charitable integration processing is achieved for making donations contactless and seamless to donors. The donations are portable and can be redeemed online, in store, at an ATM using an image of the code or using a printed image of the code on print media. Donors control the usage restrictions and funds for a donation can be obtained via linked donor credit cards, linked donor bank accounts, cash provided at a terminal 150, linked donor cryptocurrency wallets, and/or linked donor cash app services (such as PayPal®, Venmo®, Zelle®, etc.). Furthermore, donations can be made during checkouts at terminal or online stores, at ATMs during financial transactions of a donor, or via app 124 whenever the donor chooses. Donors can also transfer donations via the code to desired recipients in any number of contactless manners, such as camera scans, paper, text, NFC, airdrop®, etc.

Platform 100 provides a mechanism by which donations to homeless or those in need can be made with very little effort and in manners that do not disrupt normal activities of donors. This allows donors to feel good about helping out those in need while allowing them to control how their donations are used.

In an embodiment, the transaction terminals 150 can include ATMs, Point-Of-Sale (POS) terminals, or Self-Service Terminals (SSTs).

In an embodiment, at any point before a donation associated with a one-time recipient wallet is redeemed, the original donor can log into cloud/server 110 and add, remove, or change the donor-based restrictions. Thus, if a donor forgot to place an age restriction on the donation for a minor given the code for the recipient wallet, the donor can add the age restriction after the fact as long as the minor had not already redeemed the donation from the code.

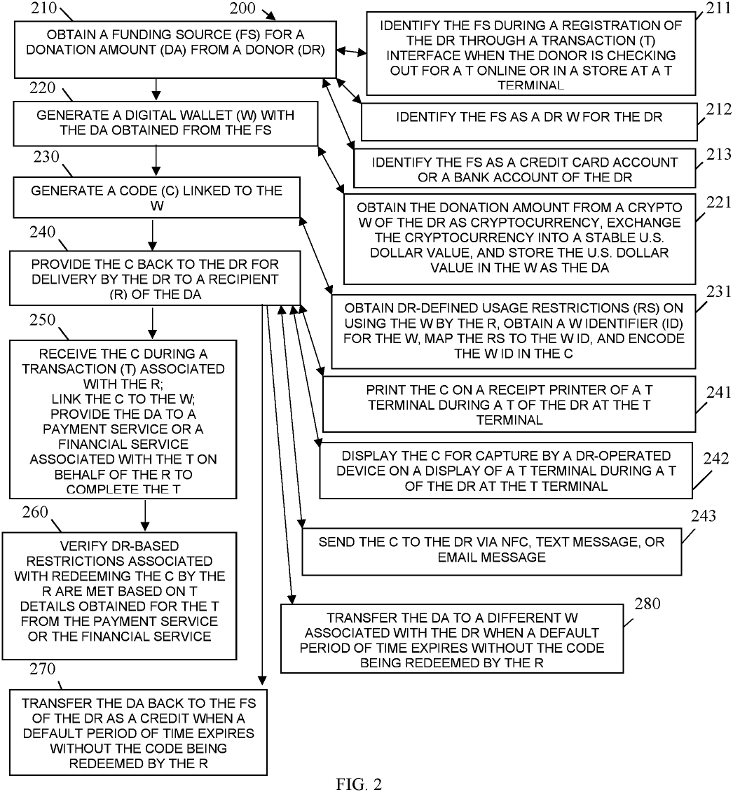

The above-referenced embodiments and other embodiments are now discussed within FIGS. 2—3.

FIG. 2 is a diagram of a method 200 for charitable platform integration processing, according to an example embodiment. The software module(s) that implements the method 200 is referred to as a “donation manager.” The donation manager is implemented as executable instructions programmed and residing within memory and/or a non-transitory computer-readable (processor-readable) storage medium and executed by one or more processors of one or more devices. The processor(s) of the device that executes the donation manager are specifically configured and programmed to process the donation manager. The donation manager may have access to one or more network connections during its processing. The network connections can be wired, wireless, or a combination of wired and wireless.

In an embodiment, the device that executes the donation manager is a cloud 110. In an embodiment, the device that executes the donation manager is server 110.

In an embodiment, donation manager is all or some combination of 113, 114, and 115.

At 210, the donation manager obtains a funding source for a donation amount from a donor.

In an embodiment, at 211, the donation manager identifies the funding sources during a registration of the donor through a transaction interface when the donor is checking out for a transaction online or in a store at a transaction terminal 150.

In an embodiment, at 212, the donation manager identifies the funding source as a donor digital wallet for the donor.

In an embodiment, at 213, the donation manager identifies the funding source as a credit card account associated with the donor, a bank account associated with the donor, or a payment service account associated with the donor.

At 220, the donation manager generates a new and temporary digital wallet with the donation amount obtained from the funding source provided by the donor at 210.

In an embodiment, at 221, the donation manager obtains the donation amount from a cryptocurrency wallet for the donor as cryptocurrency, exchanges the cryptocurrency into a stable U.S. dollar value, and stores the U.S. dollar value in the generated digital wallet as the donation amount.

At 230, the donation manager generates a code linked to the generated digital wallet.

In an embodiment, at 231, the donation manager obtains donor-defined usage restrictions on using the generated digital wallet by a recipient, obtains a wallet identifier for the generated digital wallet, maps the donor-defined usage restrictions to the wallet identifier, and encodes the wallet identifier within the generated code.

At 240, the donation manager provides the code back to the donor for delivery by the donor to a recipient of the donation amount.

In an embodiment, at 241, the donation manager prints the code on a receipt printer of a transaction terminal 150 during a transaction of the donor at the transaction terminal.

In an embodiment, at 242, the donation manager displays the code for capture by a donor-operated device 120 on a display of a transaction terminal during a transaction of the donor at the transaction terminal.

In an embodiment, at 243, the donation manager sends the code to the donor via NFC, text message, or email message.

In an embodiment, at 250, the donation manager receives the code during a transaction associated with a recipient and the donation manager links the code to the generated wallet (at 220). Next, the donation manager provides the donation amount of the generated wallet to a payment service 143 or a financial service 144 associated with the transaction on behalf of the recipient to complete the transaction.

In an embodiment of 250 and at 260, the donation manager verifies donor-based restrictions associated with redeeming the code by the recipient are met based on transaction details obtained for the transaction from the payment service 143 of the financial service 144.

In an embodiment, at 270, the donation manager transfers the donation amount back to the funding source of the donor as a credit when a default period of time expires without the code being redeemed by the recipient.

In an embodiment, at 280, the donation manager transfers the donation amount to a different digital wallet associated with the donor when a default period of time expires without the code being redeemed by the recipient.

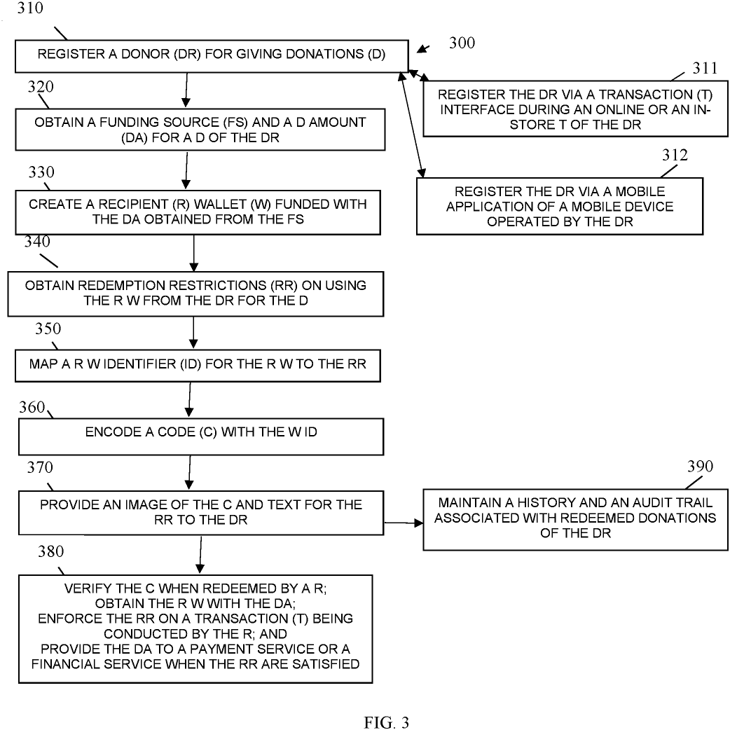

FIG. 3 is a diagram of another method 300 for charitable platform integration processing, according to an example embodiment. The software module(s) that implements the method 300 is referred to as a “cloud-based donation integration service.” The cloud-based donation integration service is implemented as executable instructions programmed and residing within memory and/or a non-transitory computer-readable (processor-readable) storage medium and executed by one or more processors of a device. The processors that execute the cloud-based donation integration service are specifically configured and programmed for processing the cloud-based donation integration service. The cloud-based donation integration service may have access to one or more network connections during its processing. The network connections can be wired, wireless, or a combination of wired and wireless.

In an embodiment, the device that executes the cloud-based donation integration service is cloud 110.

In an embodiment, the cloud-based donation integration service is some combination or all of 113, 114, 115, and/or method 200.

The cloud-based donation integration service presents another and, in some ways, an enhanced processing perspective from that which was shown above for system/platform 100 and/or method 200.

At 310, the cloud-based donation integration service registers a donor for giving donations to recipients.

In an embodiment, at 311, the cloud-based donation integration service registers the donor via a transaction interface during an online or an in-store transaction of the donor.

In an embodiment, at 312, the cloud-based donation integration service registers the donor via a mobile application 124 of a mobile device 120 operated by the donor.

At 320, the cloud-based donation integration service obtains a funding source and a donation amount for a donation of the donor.

At 330, the cloud-based donation integration service creates a recipient wallet funded with the donation amount obtained from the funding source.

At 340, the cloud-based donation integration service obtains redemption restrictions on using the recipient wallet from the donor for the donation.

At 350, the cloud-based donation integration service maps a recipient wallet identifier for the recipient wallet to the redemption restrictions.

At 360, the cloud-based donation integration service encodes a code with the wallet identifier.

At 370, the cloud-based donation integration service provides an image of the code and text for the redemption restrictions to the donor.

In an embodiment, at 380, the cloud-based donation integration service verifies the code when redeemed by the recipient, obtains the recipient wallet with the donation amount, identifies the redemption restrictions as age-based restrictions, tax code restrictions, store category restrictions, or parental restrictions, enforces the redemption restrictions on a transaction being conducted by the recipient, and provides the donation amount to a payment service 143 or a financial service 144 when the redemption restrictions are satisfied.

In an embodiment, at 390, the cloud-based donation integration service maintains a history and an audit trail associated with redeemed donations of the donor.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
providing executable instructions to a processor of a server causing the processor to perform operations, comprising:
obtaining a funding source for a donation amount from a donor during a transaction that the donor is engaged in through a transaction terminal or a donor-operated device, wherein obtaining further includes receiving the funding source from a workflow associated with a transaction interface of the transaction;
generating a digital wallet with the donation amount obtained from the funding source, wherein the digital wallet generated on behalf of a recipient who is to receive the donation amount from the donor and wherein the digital wallet is specific to the recipient;
generating a code linked to the digital wallet;
maintaining a mapping between the code, the digital wallet and a donor identifier for the donor amount, wherein maintaining further includes maintaining information for the digital wallet with the mapping, the information comprises any donor-based usage restrictions placed on the donation amount held in the digital wallet, a type of valuable funds associated with the donation amount, and the donation amount;
providing the code and the information back to the donor for delivery by the donor to therecipient of the donation amount; and
processing the code when presented by the recipient by allowing the recipient to use the donation amount included in the digital wallet during a subsequent transaction of the recipient through a recipient-operated device of the recipient or through the transaction terminal or a different transaction terminal.

2. The method of claim 1 further comprising:
receiving the code during a subsequent transaction associated with the recipient;
linking the code to the digital wallet using the mapping and obtaining the information; and
providing the donation amount to a payment service or a financial service associated with the subsequent transaction on behalf of the recipient to complete the subsequent transaction using the donor amount in the type of valuable funds held in the digital wallet.

3. The method of claim 2, wherein linking further includes verifying donor-based usage restrictions associated with redeeming the code by the recipient are met based on transaction details obtained for the subsequent transaction from the payment service of the financial service.

4. The method of claim 1 further comprising, transferring the donation amount back to the funding source of the donor as a credit when a default period of time expires without the code being redeemed by the recipient.

5. The method of claim 1 further comprising, transferring the donation amount to a different digital wallet associated with the donor when a default period of time expires without the code being redeemed by the recipient.

6. The method of claim 1, wherein obtaining further includes identifying the funding source during a registration of the donor through the transaction interface when the donor is checking out for the transaction online or in a store at the transaction terminal.

7. The method of claim 1, wherein obtaining further includes identifying the funding source as a donor digital wallet associated with the donor.

8. The method of claim 1, wherein obtaining further includes identifying the funding source as a credit card account or a bank account of the donor.

9. The method of claim 1, wherein generating the digital wallet further includes obtaining the donation amount from a crypto wallet of the donor as cryptocurrency, exchanging the cryptocurrency into a stable United States (U.S.) dollar value, and storing the U.S. dollar value in the digital wallet as the donor amount.

10. The method of claim 1, wherein generating the code further includes obtaining donor-defined usage restrictions on using the digital wallet by the recipient, obtaining a wallet identifier for the digital wallet, maintaining within the mapping the donor-defined usage restrictions and the wallet identifier, and encoding the wallet identifier in the code.

11. The method of claim 1, wherein providing further includes printing the code on a receipt printer of the transaction terminal during the transaction of the donor at the transaction terminal.

12. The method of claim 1, wherein providing further includes displaying the code for capture by the donor-operated device on a display of the transaction terminal during the transaction of the donor at the transaction terminal.

13. The method of claim 1, wherein providing further includes sending the code to the donor via Near Field Communication (NFC), text message, or email.

14. A method, comprising:
providing executable instructions to a processor of a cloud causing the processor to perform operations, comprising:
registering a donor for giving donations through interactions with the donor who is operating a donor-operated device or a transaction terminal during a transaction of the donor being processed through a workflow associated with a transaction interface for the transaction;
obtaining a funding source and a donation amount for a donation of the donor from the donor via the donor-operated device or the transaction terminal;
creating a recipient wallet funded with the donation amount obtained from the funding source by transferring the donation amount from the funding source to the recipient wallet, wherein the recipient wallet specific to and usable by just the recipient;
obtaining redemption restrictions on using the recipient wallet from the donor for the donation via the donor-operated device or the transaction terminal;
mapping a recipient wallet identifier for the recipient wallet to the redemption restrictions and maintaining information associated with the recipient wallet identifier, wherein the information comprises a type of valuable funds associated with the donation amount held in the recipient wallet and the donation amount;
encoding a code with the wallet identifier;
providing an image of the code and text for the redemption restrictions to the donor for the donor to subsequently provide to the recipient; and
processing the code when presented by the recipient by allowing the recipient to use the donation amount held in the recipient wallet during a subsequent transaction associated with the recipient through a recipient-operated device of the recipient or through the transaction terminal or a different transaction terminal.

15. The method of claim 14 further comprising, verifying the code when redeemed by the recipient, obtaining the recipient wallet with the donation amount; identifying the redemption restrictions as age-based restrictions, tax classification-based restrictions, parental restrictions, or store category based restrictions; enforcing the redemption restrictions on the subsequent transaction being conducted by the recipient; and providing the donation amount to a payment service or a financial service associated with the subsequent transaction when the redemption restrictions are satisfied.

16. The method of claim 14 further comprising, maintaining a history and an audit trail associated with a redemption by the recipient of the donation amount on behalf of of the donor.

17. The method of claim 14, wherein registering further includes registering the donor via the transaction interface during an online transaction conducted via the donor-operated device or during an in-store transaction of the donor at the transaction terminal.

18. The method of claim 14, wherein registering further includes registering the donor via a mobile application of a mobile device operated by the donor.

19. A system, comprising:
at least one server comprising a processor and a non-transitory computer-readable storage medium;
the non-transitory computer-readable storage medium comprising executable instructions;
transaction terminals;
a donor-operated device; and
a recipient operated device;
wherein the executable instructions when provided to the processor cause the process to perform operations, comprising: :
registering a donor for donations during a first transaction at a first transaction terminal through a first transaction interface of the first transaction terminal through a first workflow associated with the first transaction interface for the first transaction;
obtaining a funding source for a donation of a donation amount from the donor during the first transaction through the first transaction interface;
obtaining donor-defined usage restrictions on the donation amount during the first transaction;
generating a recipient digital wallet funded with the donation amount obtained from the funding source and map the donor-defined usage restrictions to a wallet identifier for the recipient digital wallet during the first transaction, wherein generating further includes maintaining information for the wallet identifier, wherein the information comprises a type of valuable funds associated with the donation amount held in the recipient digital wallet and the donation amount, wherein the recipient digital wallet generated on behalf of a recipient who is to receive the donation amount from the donor and wherein the recipient digital wallet is specific to the recipient;
encoding a code with the wallet identifier during the first transaction;
causing the first transaction interface to display an image of the code and text for the donor-defined usage restrictions on a display of the first transaction terminal to be captured by the donor-operated device off the display of the first transaction terminal;
receiving the code during a second transaction at a second transaction terminal from a code image displayed on recipient display of the recipient-operated device by the recipient and captured and provided by a second transaction interface to the at least one server during the second transaction, wherein the code is received through a second workflow associated with the second transaction interface for the second transaction;
receiving transaction details from the second transaction interface for the second transaction of the recipient;
decoding the code image and obtaining the wallet identifier and the information associated with the wallet identifier;
obtaining the recipient wallet and the donor-defined usage restrictions mapped to the wallet identifier; and
providing the donation amount as a partial or a full payment for the second transaction of the recipient from the recipient wallet when the donor-defined usage restrictions are satisfied by the transaction details.

20. The system of claim 19, wherein the transaction terminals comprise Automated Teller Machines (ATMs), Point-Of-Sale (POS) terminals, and Self-Service Terminals (SSTs).
